(19) United States
(12) Patent Application Publication
(10) Pub. No.: US 2005/0288949 A1
(43) Pub. Date: Dec. 29, 2005

(54) Method of employing a computer network for disseminating information to economic development practitioners

(76) Inventor: Donald Holbrook, Lake Havasu City, AZ (US)

Correspondence Address: Michael J. Colitz, III;Holland & Knight LLP, Suite 4100, 100 N. Tampa St., Tampa, FL, 33602-3644, US

(21) Appl. No.: 11/031,521

(22) Filed: Jan. 6, 2005

Related U.S. Application Data
(63) Continuation-in-part of application No. 10/137,199, filed on May 2, 2002, now abandoned.
(60) Provisional application No. 60/288,945, filed on May 4, 2001.
(60) Provisional application No. 60/288,679, filed on May 4, 2001.

(51) Int. Cl. G06Q 99/00

(52) U.S. Cl. 705/1

(57) ABSTRACT

Disclosed is a method of employing computer network to disseminate information regarding economic development. The method enables economic development professionals to access a database of various economic development courses. Specific economic development information is stored in a resource index database which individual economic development professionals are allowed to access and review information relevant to a selected course.

### RELATED APPLICATION DATA

This application claims priority from provisional application Ser. No. 60/288,945 filed on May 4, 2001 entitled Economicdeveloper.com, the contents of which are incorporated herein by reference. This application also claims priority from provisional application Ser. No. 60/288,679 filed on May 4, 2001 entitled Site Selection RFP/Lead Generation System, the contents of which are incorporated herein by reference. This application is a continuation-in-part of co-pending application Ser. No. 10/137,199, the contents of which are incorporated herein.

### BACKGROUND OF THE INVENTION

1. Field of the Invention

This invention relates to a computerized network for disseminating information to economic development practitioners. More particularly, the present invention relates to a method of employing the internet for the educating and informing such practitioners of developments in the economic development field.

2. Description of the Background Art

Presently it is known to employ to the Internet to offer business leads on line. For example, www.globalbizdir.com and www.localbusiness.com function as virtual marketplaces for economic development activities. Likewise U.S. Pat. No. 6,112,188 to Hartnett discloses a computerized method for developing and implementing economic policies. The method includes the step of preparing a privatization business plan, reviewing a privatization plan by a privatization board, executing the plan, restructuring the enterprise in accordance to the plan and submitting an application for certification of demonopolization to a privatization board. These steps are carried out by way of a computer system.

Furthermore it is also known to employ the Internet for more general economic activity. For instance, U.S. Pat. No. 6,247,130 to Fritsch discloses a system and method for permitting the purchase of audio music files over the Internet. Likewise U.S. Pat. No. 6,078,866 discloses an Internet site searching and listing service based upon monetary rankings of site listings.

Although each of the above referenced inventions achieves its individual objective, they all suffer from common problems. Specifically, none of the background art discloses the use of a computer network to disseminate information to economic development practitioners. Moreover none of the background art discloses utilizing a computer network for educating individuals in the field of economic development on as interactive basis.

### SUMMARY OF THE INVENTION

The present invention relates to a method of employing a computer network for dissemination of information to economic development practitioners. In one embodiment, the method takes the form of a multifunction, Web-based practice resource and Web portal that enhances distribution of knowledge and facilitates communication between economic developers and their industry associates. In addition to its five practice resource functions, the method promotes business-to-consumer (B2C) and peer-to-peer (P2P) sale and distribution of industry-specific information, services, and knowledgeware products. Its flexible business model supports the industry's first just-in-time sale of knowledgeware products, fee-for-service online distribution of practice resources, and compensation processing for expert contributors.

When employed over the Internet, the method incorporates various activities intended to enhance the national, state, or local economy by promoting the community's business environment and investment climate. Typically, these activities are carried out by economic development officials (EDOs) representing public sector interests.

Over the past thirty years, the economic development (ED) field has become increasingly professionalized. Today, ED is taught in colleges and universities; professional certification is awarded for specialized training; the field has it own journals and industry organizations; and regional, national, and international conferences are held regularly.

The International Economic Development Council (IEDC), the industry's leading membership organization, has proactively worked to establish professional certification training and industry standards for community data. But despite ED's growing professionalism, the field has been slow to develop a technological infrastructure to disseminate technical and professional resources to support ED practice. The present invention provides this technology platform and delivers the first Web-supported practice resource designed for ED practitioners.

The method of the present invention offers EDOs five essential practice tools:
Electronic Newsletter
Knowledgeware Library
Moderated Chat Room Sessions
Economic Development Resources
Résumé Posting Service/Job Posting Listserv

Each of these practice tools, their associated B2C and P2P e-commerce features, and the resource index search function are described in detail in the following section.

It is one of the objectives of this invention to provide a means to conveniently and quickly disseminate information to economic development professionals.

It is also an object of this invention to employ a computer network to provide a virtual classroom wherein users can gain information regarding economic development activities.

Still another object of this invention is to disseminate economic development information via an electronic newsletter which is sent to users of the present invention.

These and other objectives are accomplished by providing a method of employing computer network to disseminate information regarding economic development. The method enables economic development professionals to access a database of various economic development courses. Specific economic development information is stored in a resource index database which individual economic development professionals are allowed to access and review information relevant to a selected course.

The foregoing has outlined rather broadly the more pertinent and important features of the present invention in order that the detailed description of the invention that follows may be better understood so that the present contribution to the art can be more fully appreciated. Additional features of the invention will be described hereinafter, which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is an overview of the method of the present invention.

FIG. 2 is a flowchart depicting the new user interview process aspect of the present invention.

FIG. 3 is a flowchart depicting the user login aspect of the present invention.

FIG. 4 is a listing of the different types of users of the method of the present invention.

FIG. 5 is a flowchart depicting the ED pro agent aspect of the present invention.

FIG. 6 is a flowchart depicting the information agent aspect of the present invention.

FIG. 7 is a flowchart depicting the shopkeeper agent aspect of the present invention.

FIG. 8 is a flowchart depicting the electronic newsletter aspect of the present invention.

FIG. 9 is a flowchart depicting the economic development resources agent aspect of the present invention.

FIG. 10 is a flowchart depicting the SME directory aspect of the present invention.

FIG. 11 is a flowchart depicting the moderated chat room session aspect of the present invention.

FIG. 12 is a flowchart depicting the resume posting/job posting listserv aspect of the present invention.

FIG. 13 is a flowchart depicting the professional distance education system aspect of the present invention.

Similar reference characters refer to similar parts throughout the several views of the drawings.

### DETAILED DESCRIPTION OF THE PREFERRED EMBODIMENT

The present invention relates to a method of employing a computerized network for disseminating information to economic development practitioners. Economic development practitioners (EDP) are individuals who are engaged in various activities intended to enhance the national, state, or local economy by promoting a communities business environment and investment alignment.

The method of the present invention allows EDPs to access a database listing of economic development courses. The EDP is further given access to a resource index database containing various economic development (ED) information. Thereafter, in accordance with the method, the EDPs can take a quiz or test over the computer network after which the quiz is graded comparing the EDP's answers to the answers stored in the resource index database. On the basis of the quiz grade, the EDP is routed to a chat room for an online discussion with a subject matter expert (SME). The various features of the method of the present invention, as well as the additional features, are discussed in greater detail hereinafter.

The method of the present invention involves a computer network that is employed in disseminating information to EDPs. In the preferred embodiment, the computer network takes the form of the World Wide Web. The various blocks illustrated in the figures each represent one or more web pages in HTML format. As is known in the art, the HTML code would be resident upon a server and accessible by an individual computer.

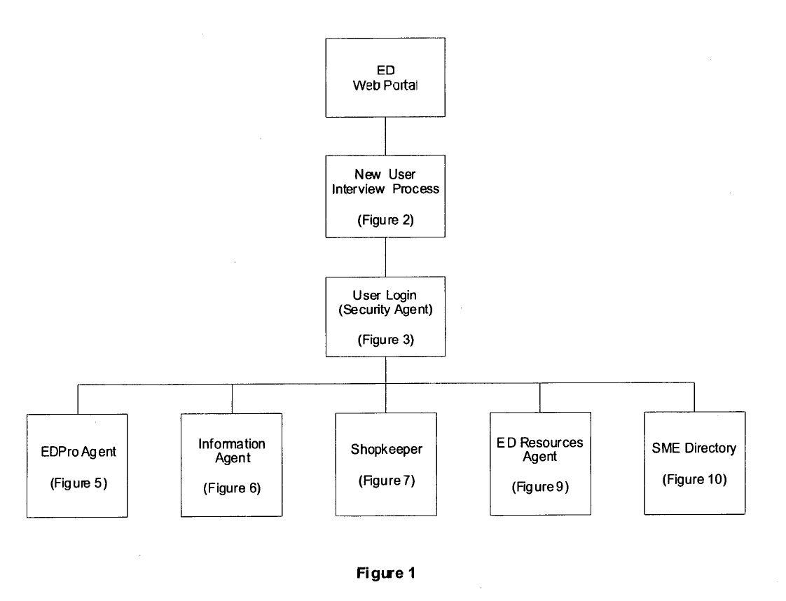

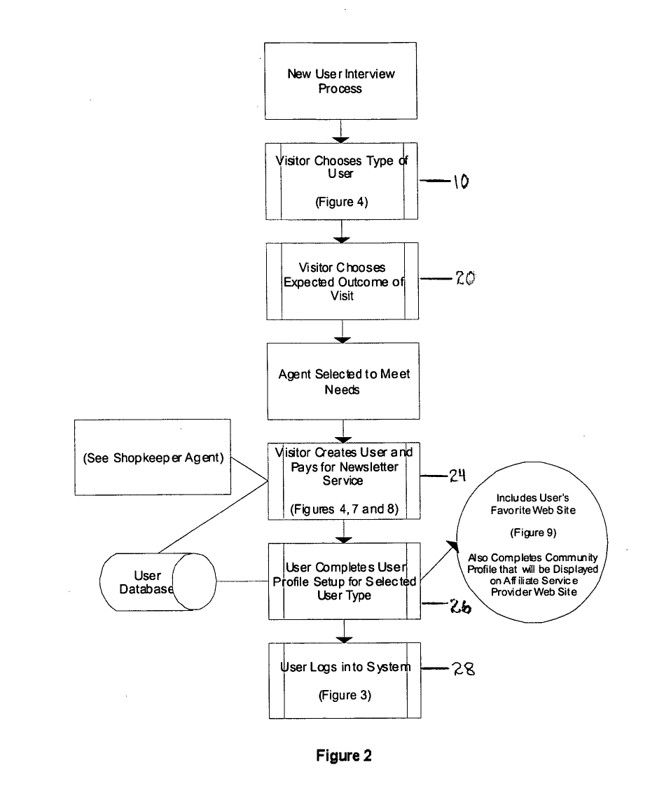

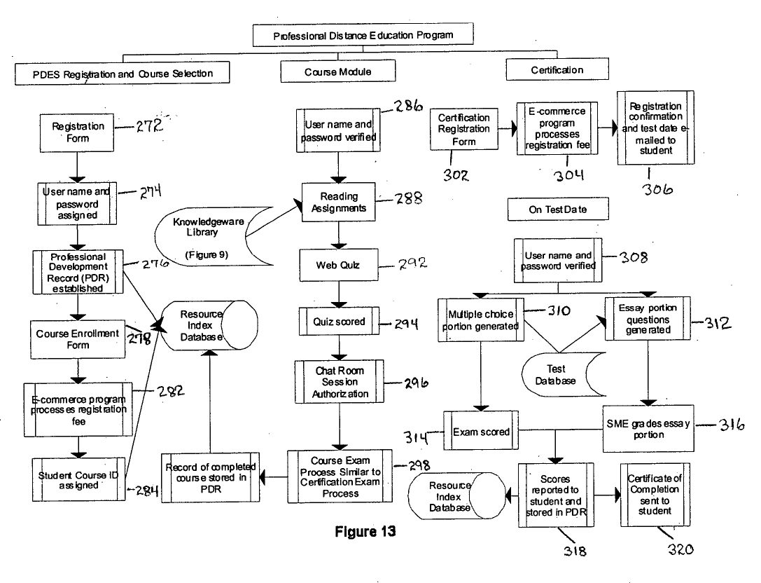

In accordance with the first step of the method a user of the network is assigned a user name and password which allows the individual EDP to access a database containing a listing of various economic development courses, as well as descriptions of the economic development courses. The logon feature is discussed more fully hereinafter in conjunction with FIGS. 1-2. The development courses, or distance learning, aspect of the method is described more fully hereinafter and illustrated in the flowchart of FIG. 13. After viewing the listing of economic development courses the EDP selects a course they are interested in taking. The database is then updated with the users name an their selected course.

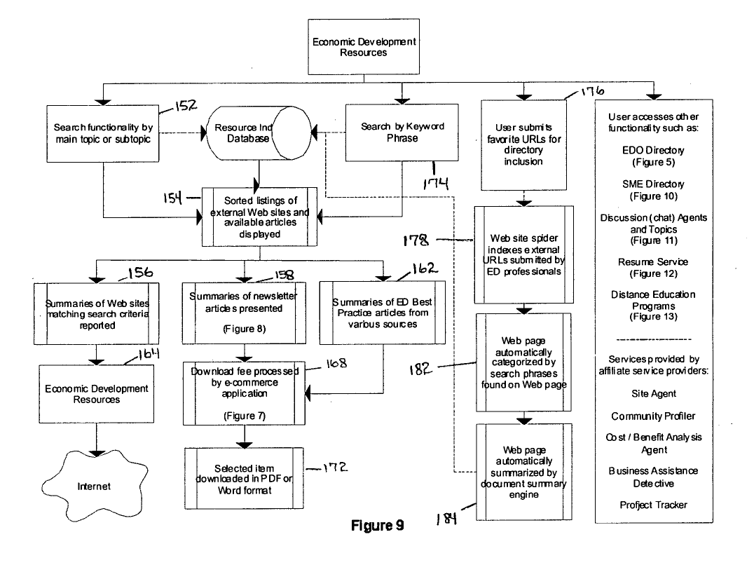

Once the course is selected the EDP is given access to a resource index database which contains economic development articles and summaries of relevant economic development websites. The EDP can search the database for information relevant to their selected economic development course. This aspect of the present invention is more fully elaborated hereinafter and is illustrated in the flowchart of FIG. 9.

The resource index database is also used to store test questions as well as answers to test questions (note FIG. 13). These test questions are classified on the basis of the economic development courses. That is, certain test questions are relevant to certain economic development courses. During the course, individual EDPs are permitted to access the test questions and further permitted to provide their own answers. Thereafter the answers of the EDP are graded by comparing the answers provided by the EDP to the answers stored in the resource index database. On the basis of this score a grade is assigned to EDP (FIG. 13, location 294).

On the basis of the assigned grade, a chat room session or newsgroup code is assigned (FIG. 13, location 296). By way of the session code, the EDP is given access to an online chat session with a relevant subject matter expert (note FIG. 11). The subject matter expert then interacts with the EDP over the computer network and answers any questions posed by the EDP which are relevant to the selected economic development course that the EDP is taking. After the course is complete a record is compiled as to which individual EDP has taken which course. This record is then stored in the resource index base.

Now that the invention has been described from a broad prospective, the individual subpages which constitute the website of the preferred embodiment will be described in greater detail.

### Logging On to the System

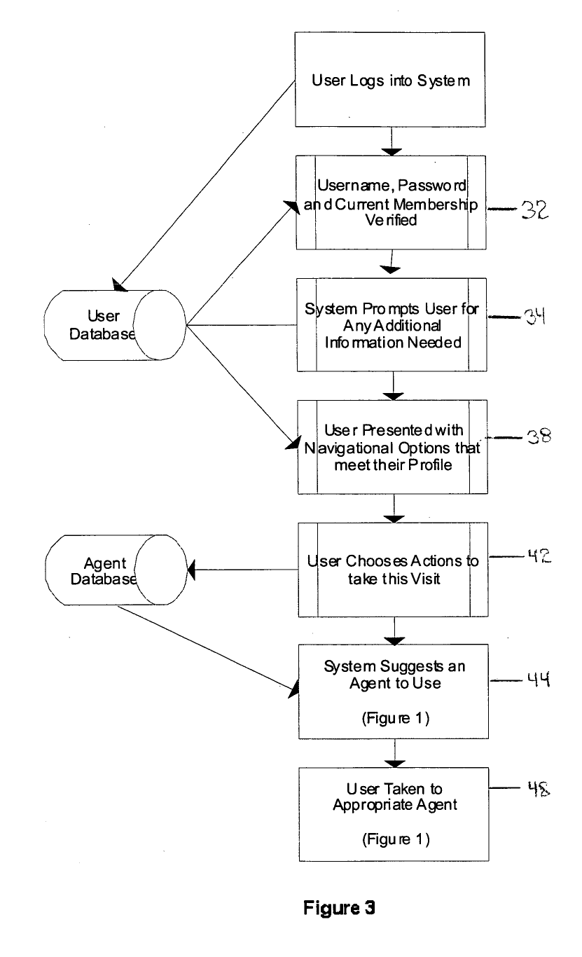

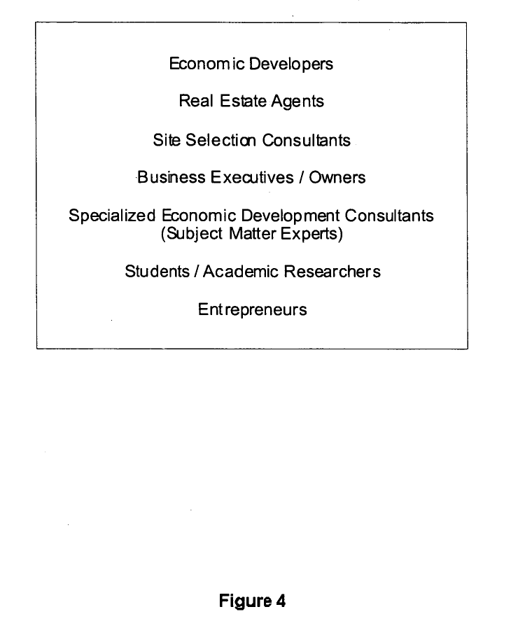

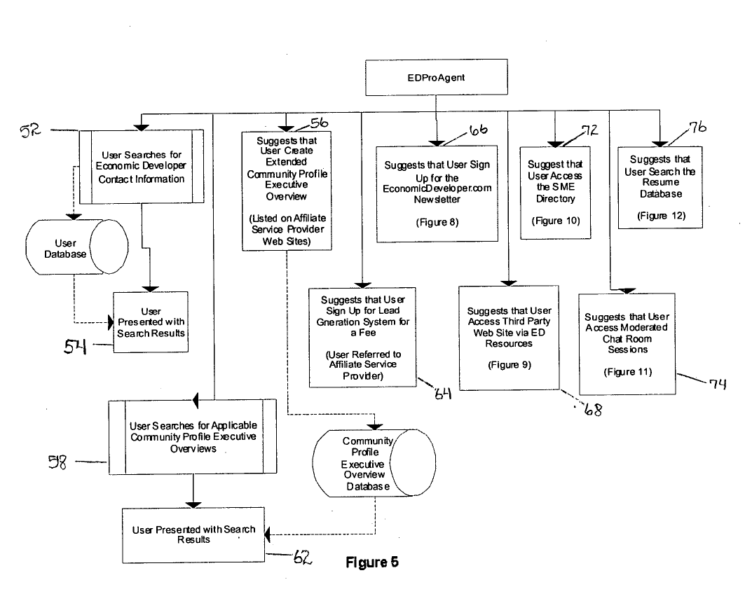

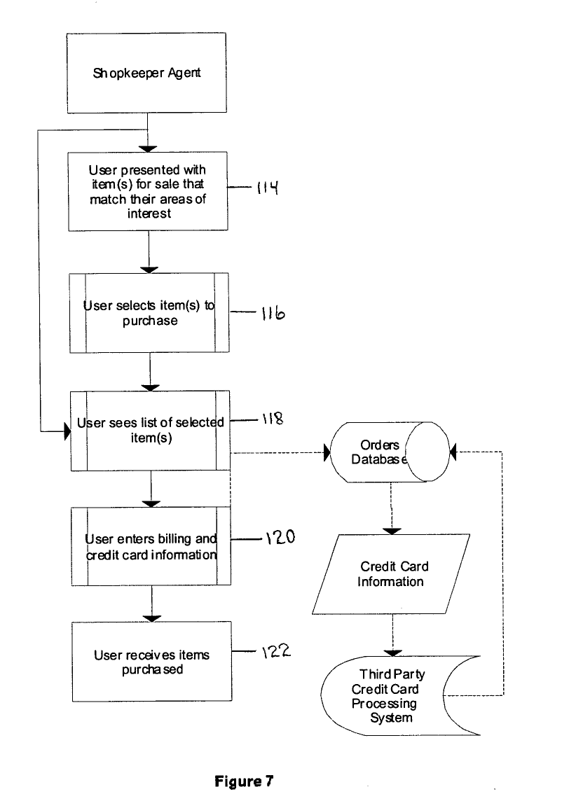

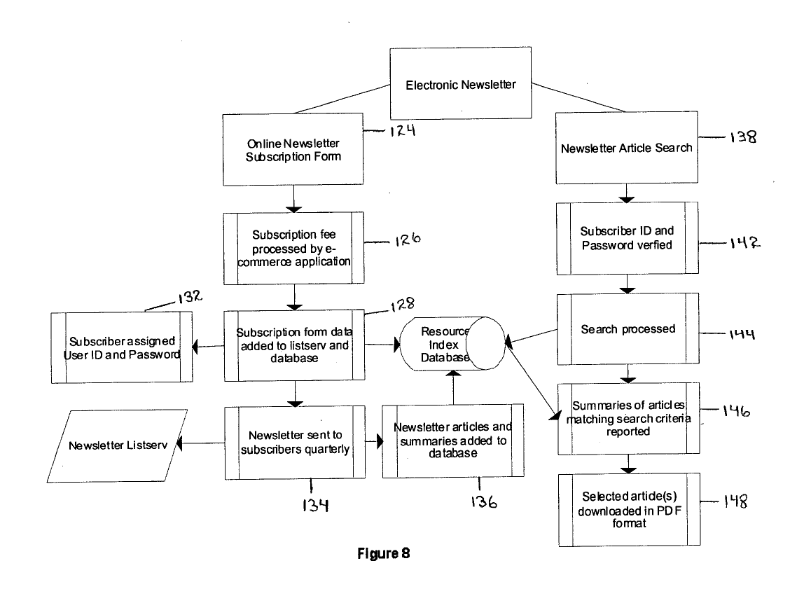

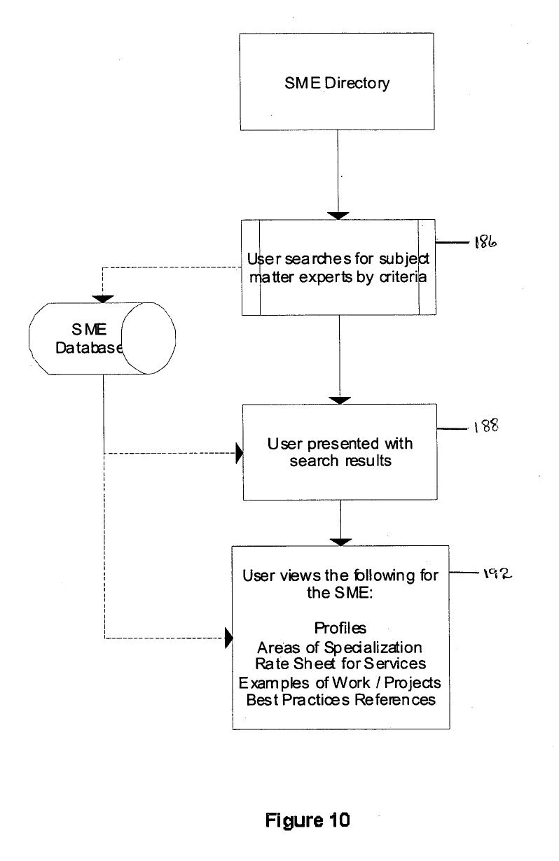

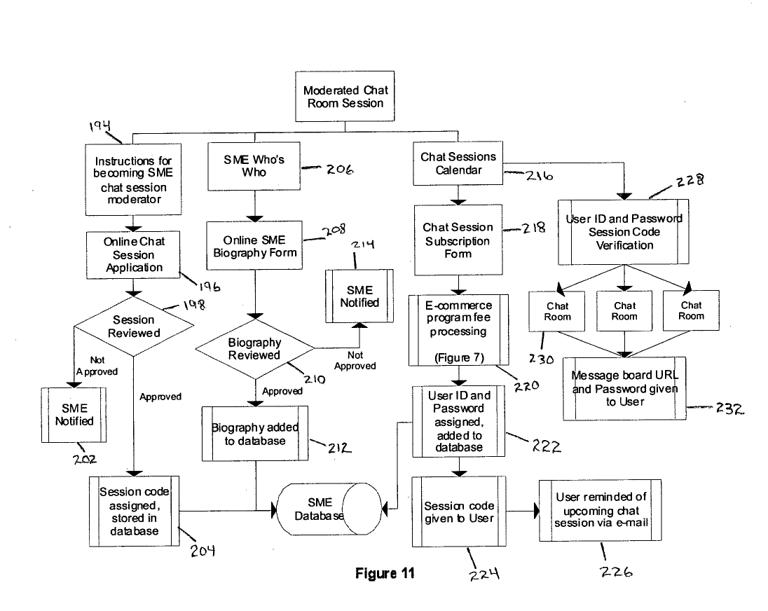

With reference now to FIGS. 2 and 3 the logon and data input aspects of the method are described. FIGS. 2 and 3 illustrate the initial steps of the present invention. As with FIG. 1, FIGS. 2 and 3 are flowcharts with each block depicting one or more web subpages in HTML code that can be accessed by a user. In the new user interview process depicted in FIG. 2 at location 10, an individual first decides which type of user they are. The most typical user types are listed in FIG. 4. However, most all users to the site will be classified either as economic developers or site selectors. All visitors to the site are broadly classified as Economic Development Professionals (EDPs). Next at location 20 the visitor chooses the expected outcome of their visit. Namely the user specifies that information which they are seeking or those objectives they which to achieve by employing the site. On the basis of this input a particular “agent” is selected. That is, that area of the web site (as noted in FIG. 1 and in more detail in FIGS. 5 through 10) which is most capable of assisting the user is selected. Finally, the user creates a user profile and tenders payment for use of the website (location 24). Finally, additional user profile information can be requested at location 26 and thereafter the user can logon to the system (location 28).

The user logon is depicted in the flowchart of FIG. 3. Logging on is achieved by a user providing their user name password and current membership information as illustrated at location 32. All this information is checked relative to a user database. As is typical in such situations, the system can prompt the user for any additional login information that is needed (note location 34). The user database is then accessed to present the user with navigational options (location 38) that are specific to their user profile. Thereafter the user decides what actions they will take during their visit to the website (location 42). The desired action is then compared to an agent database and the system suggests a particular agent to use (location 44). Again the agent is an indication of which portion of the website is most like to achieve the objectives of the user. The various agents contained within the site are depicted in the lower half of FIG. 1. Thereafter the user is taken to an appropriate agent (location 48).

### ED Pro Agent

One of the agents, or subpages, that the EDP can visit is the ED pro agent. By way of the ED pro agent the user can access various features in the website. For instance, the user can search for economic developer contact information (location 52). The contact information can take the form of phone numbers or email addresses of other economic developer professionals. Moreover, the contact information database can be searched to find EDPs with specified background and within a specific geographic location. This searching is done on a user database. The results of any search would be presented to the user in a graphical format (note location 54).

Likewise the ED proagent enables a user to generate a community profile executive overview such that other economic development professionals can search for relevant community profiles (note location 56 through 62). This aspect of the present invention is discussed in the co-pending and concurrently filed patent application entitled A Method of Employing a Computer Network to Regulate Contact Between Economic Officials and Site Selectors. Furthermore the user can access the lead generation system which is also described in the co-pending application (note location 64). Furthermore by way of the ED proagent, a user can gain access to the other functionality available through the website. That is the user can gain access to the newsletter function (note location 66), other economic development resources (note location 68), can gain access to an SME directory (note location 72), can gain access to chat room sessions (note location 74), or it can use the resume database (note location 76). Each of these features is elaborated upon hereinafter.

### Information Agent

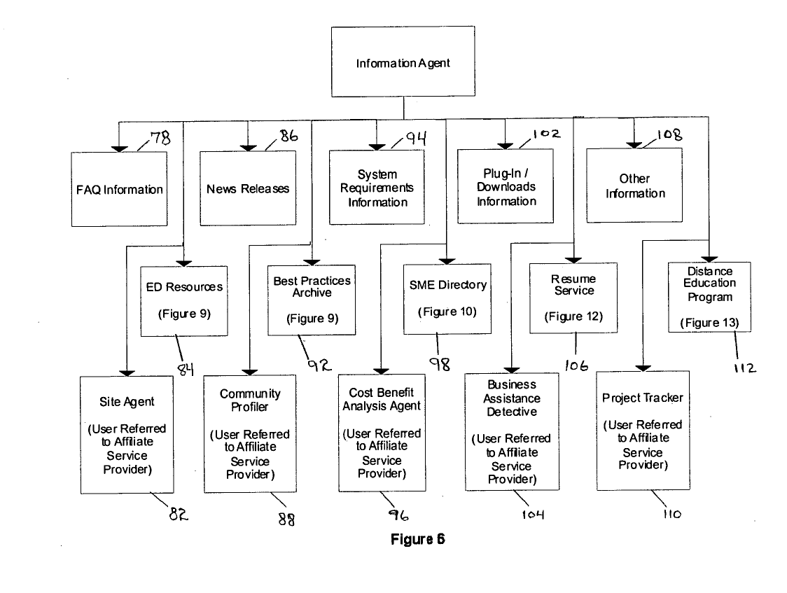

The information agent aspect of the method is described next in conjunction with FIG. 6. By way of the information agent a user can access various information subpages. For example, a user can access a page of frequently asked questions (note location 78), a page of news releases relevant to economic development community (note location 76), information regarding the system requirements for employing various functionality within the website (note location 94), or they can gain access to plug-ins and downloads to update their computer as necessary (note location 102). Other information can be included in the various subpages as needed (note location 108). Likewise the information agent would also serve as a portal to again gain access to the other functionality located within the site (note locations 84, 92, 98, 106, 112). Again, the functionality described in applicants co-pending application can also be accessed through the information agent portal (note locations 82, 88, 96, 104, 110).

### Shopkeeper Agent

In the shopkeeper agent aspect of the present invention, once the user logs into the system a database is continually updated with the users preferences as well as another relevant information gathered during the interview process. For example, the database an record which websites the user frequently visits as well as any personal information supplied by the user in the interview process. On the basis of this information the user would is presented with items for sale that match their areas of interest (note location 114). The user would then be permitted to select the items that they desire (note location 116). Thereafter, the use is presented a listing of their selected items (note location 118). The user would enter billing and/or credit card information to receive the purchased items (note locations 120 and 122).

### Electronic Newsletter

Under the electronic newsletter aspect of the present invention the user would fill out an online newsletter subscription form (note location 124). This subscription fee would then be processed by an E-Commerce application (note location 126). The subscription data would then be stored in a database and the subscriber assigned a user ID and password (note locations 128 and 132). The newsletter would be sent to subscribers on a quarterly or other regular basis (note location 134). Although “newsletter” is specified, any electronic publication is within the scope of the present invention including electronic magazines or “e-zines.” In the preferred embodiment, the newsletter is sent out via email via a listserv. A listserv is a compiled database of the email address of subscribers to the newsletter. After being distributed, the newsletter articles and summaries would be added to a resource index database (note location 136). The database is indexed by economic development terms and phrases. This database could then be searched (note location 138) after the entry of a subscriber ID and password (note locations 142 and 144). The search would generate summaries of articles matching the search criteria (note location 146). A user could then downloaded selected articles in a PDF (or other preferred) format (note location 148).

### Economic Development Resource Agent

The economic development resource aspect of the present invention permits searching of the resource index database. Specifically, a users can search the resource index database by main topic or subtopic (location 152) or by a keyword or phrase (location 174). As indicated, the resource index database stores both past newsletter articles as well as other articles from various sources such as economic development best practice articles. The resource index database further stores summaries of websites which are of particular relevance to the economic development community.

By searching the resource index database, relevant listing is generated of external websites and available articles (location 154). More specifically, as a result of a search the user is presented with either summaries of websites matching the search criteria reported (location 156), summaries of newsletter articles presented (location 158), or summaries of articles from various other sources (location 162). If website summaries are displayed the user would be given direct access to that particular Internet site. Alternatively, if articles are displayed the user would be able to download them for a fee processed by an E-Commerce application (note location 168). After the fee is processed the article can be downloaded in a PDF or WORD format (location 172). Of course, other document formats can be employed.

In order to keep the resource index database updated with relevant websites, users would submit their favorite URLs for directory inclusion (note location 176). Thereafter website spiders would crawl the Internet and index the external URLs submitted by the EDPs (location 178). These websites would be automatically categorized by search phrases found on the webpages (location 182). The website would then be automatically summarized by document summary by a document summary engine (note location 184). This information would then be provided to the resource index database. Again, the other functionality described herein as well as the functionality described in the applicant's co-pending patent application would all be accessible through the economic development resources agent. All information stored on the database would be indexed according to the following categories: waterfront, business part, redevelopment, new development, brownfield reuse, base closure mitigation, airports, downtown, historic renovation.

### SME Directory

The SME directory is a database containing information regarding subject matter experts (SME) with knowledge relevant to the economic development field. This SME database can searched by criteria to find relevant experts (location 186). As a result of the search, a user is presented with various search results (location 188). The search results would contain the following information: the SME's profile, their area of specialization, their rate sheet for services, examples of their work and best practices or references (note location 192).

### Moderated Chat Room Sessions

Under the moderated chat room sessions aspect of the present invention those SMEs wishing to be a chat session moderator would be given appropriate instructions (location 194). The SME would then fill out an online chat session application form (location 196). The application constitutes a request by an SME to the operator of the site to host on on-line dialog or “chat” on a specific ED topic. The proposal for a chat session is then reviewed (location 198) by the appropriate operators. If it is not approved the SME is so notified (note location 202). Otherwise a session code is assigned and stored in the SME database (note location 204).

Furthermore, the chat room session aspect of the invention allows any SME to submit online biographies form in a who's who format (note locations 206 and 208). The biographies are reviewed by operators of the site (location 210). If the biography is approved, the relevant biographical information is provided to the SME database (location 212). If the biography is not approved, the SME is so notified (location 214).

Further in accordance with the chat room session aspect of the invention, there are one or more subpages displaying a chat session calendar (location 216). The calendar displays which SMEs are hosting chat sessions as well as the chat topic. Those non-SME users who desire a particular chat session are given access to a subscription form (location 218). The subscription involves a program fee which is processed by an E-Commerce application (location 220). After the fee is processed the user is assigned a password and ID, and with information being supplied to the SME database (location 222). Thereafter a specific session code is given to the user and the user is reminded of their upcoming chat session via email (note locations 224 and 226). Once the particular date for the chat session arrives, the user logs on to the web page (location 228) and supplies their user ID and password. The user is routed to the particular chat room for which they signed up (location 230). At the conclusion of the chat session, the user is given access to a message board URL and a password which enables the user to post comments concerning the chat session for up to 30 days (location 232).

### Resume Posting Service/Job Posting Listserv

In the resume posting aspect of the present invention, users are given access to a website subpage displaying the terms and conditions for the resume service (location 234). Thereafter, the candidate fills out a profile and registration form (location 236). This profile and the associated resume, are then added to the resource index database (location 238), and the user is assigned an ID and password (location 242). Next, the user fills out a subscription form whereby they are notified via email of relevant job postings (location 244). The subscription fee for such job posting listserv is processed by an appropriate E-Commerce application (location 246). Thereafter the candidate is added to the listserv (location 248). The listserv would be the listing of all email addresses of candidates who have subscribed to the job posting subscription service. Subscribers are sent regular renewal notices prior to their job posting subscription expiring (location 252).

The particular candidate can subsequently access their profile and resume with their assigned user ID and password (location 254). This would allow them to update their resume or profile with new information (location 256). The updated resume and/or profile is then added to the resource index database (location 258).

From the recruiter side of the resume posting service, the recruiter can fill out a candidate profile search form (location 262). The recruiter then submits the form which indicates which type of candidates they were interested in hiring. The system allows recruiters to conduct a search of the resource index database based upon their desired candidate characteristics (location 264). As a result of this search profiles and/or resumes matching the search criteria are reported to the recruiter (location 266).

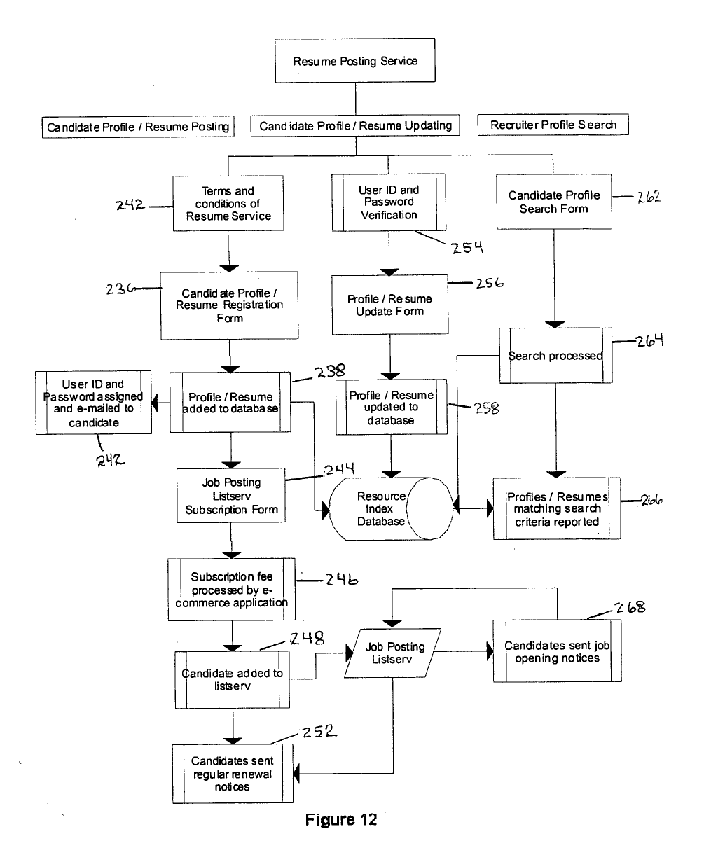

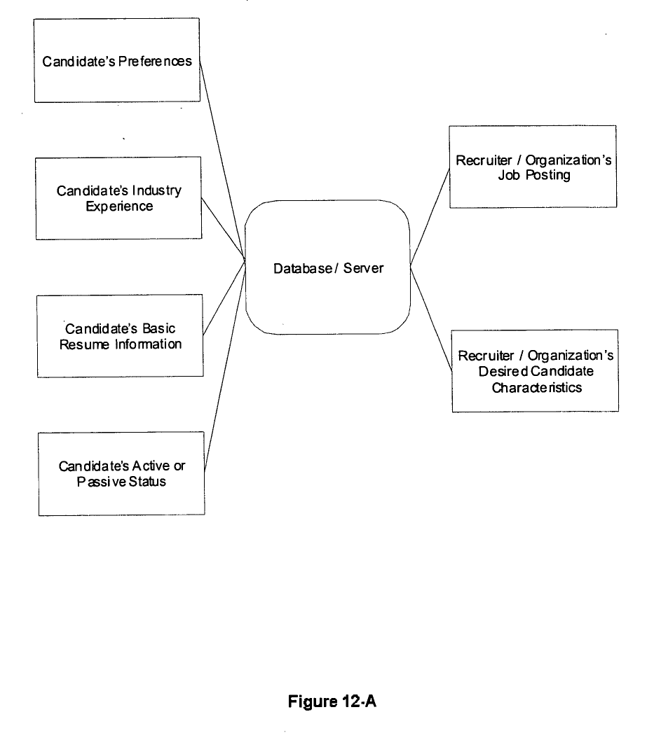

Another embodiment of the resume posting aspect of the present invention is illustrated in FIG. 12-A. As with the primary embodiment, this embodiment would be carried out over the Internet, with a central database and server being accessed via a series of webpages. In this embodiment the job-seeking EDP (or candidate) is presented with a number of different menus (which are one or more webpages in HTML format) by which the candidate can input preferences regarding their desired economic development job. These preferences would then be stored in the database and accessed by recruiters or organizations looking to hire an EDP. The inputted preferences include: type of agency the candidate wants to work for; anticipated salary range and benefits; desired size of population or market size of community in which the candidate wants to work; geographic preferences; and whether candidate is seeking a job in either rural or urban redevelopment. The candidate then weighs these preferences on a scale of 1-5 such that any relevant job openings can be ranked when presented to the candidate.

The candidate is also presented with a number of different menus by which they can profile any relevant industry experience. Specifically, the user will be prompted to provide their experience in the following areas: real estate development, finance, business attraction, marketing, business retention and expansion, brownfield redevelopment, base/federal installation redevelopment and reuse, historic redevelopment and downtown development. Of course, additional industry experience can also be provided as needed.

The user will likewise be prompted to provide basic resume information. This information will include: contact information; career goals and objectives; personal preferences; professional experience; employment history; certifications and educational attainment; specific industry accolades, and case examples for best practices that the candidate has participated in and desires to use as examples.

Finally, the candidate will be prompted to specify how they want to be alerted of relevant job openings. Specifically, along with all of the candidate's information (collectively referred to as a profile), the database will store whether the candidate has selected an active or passive alert system. In the passive system, the candidate can access the database to view all job postings that meet their designated preferences, however, in the passive mode the candidate remains completely anonymous. Namely, the system allows recruiters/organizations to simply post job listings for all candidates to view. If the candidate so desires, they can send their profile to selected recruiters/organizations who post jobs meeting their preferences, but the candidate's identity is not disclosed automatically. In contrast, with the active system, the database prompts recruiters and organizations to provide the characteristics of their preferred job candidate, after which relevant candidate profiles are automatically made available. The preferred characteristics the recruiters/organizations are prompted to provide include: years of experience; geographic location preferences; educational attainment; certifications required. Again, other characteristics can be used as needed. The server then conducts a comparison of candidate profiles relative to the recruiter/organization's preferences and then displays the profiles of candidates meeting the desired characteristics. In the active system, the candidate profiles are then sent directly to the recruiter/organization. The candidate can be notified, via email, that their profile has been sent. In an alternative embodiment, no notice is provided to the candidate and the recruiter/organization remains anonymous. Of course the candidate's entire profile is stored in the database and can be updated whenever needed.

The server can also automatically send out emails to all candidates and recruiters/organizations to notify users of new job or profile postings. Individual email accounts can be used or, in the alternative, specialized email accounts can be set up to allow for anonymity (e.g. john.doe@economicdeveloper.com). The email to these accounts can be either accessed directly or they can be automatically forwarded to the user's primary email account.

The system will also alert candidates via email on a yearly basis to update their resume, preferences and action or passive status. The email accounts can also be used by candidates to send cover letters to recruiters/organizations. These letters can be automatically generated (with the name of the recruiter/organization being automatically filled in). Finally, the server can also send emails to all users whenever a posted job is filled. The server can also send emails to the relevant recruiter/organization to determine the characteristics of the successful candidate. Public relations emails can also be sent to announce new job placements.

### Professional Distance Education System

In the distance education system, a particular EDP fills out a registration form (location 272). As a result of the registration, a user name and password are assigned (location 274) and a professional development record established (location 276). The user is then given a course enrollment form (location 278). Upon payment of an appropriate fee, a student course ID is assigned (locations 282 and 284). The student ID assigned to the particular EDP is then stored in the resource index database.

Once the registration is complete, the user can access the system to take a course by presenting their user name and password (location 286). Based upon their particular course selection. The user is given appropriate reading assignments (location 288). The reading assignments is carried out by reference to the resource index database discussed in conjunction with FIG. 9. After the appropriate reading assignment are completed the user is given an automated quiz (location 292). The quiz is scored by referencing the answers provided by the EDP student relative to the resource index database (location 294). On the basis of the score a chat room session is authorized (location 296). The chat room enables the student to interact with a SME to discuss any of the answers that were missed during the quiz. The site may also be used to administer a final exam or certification exam at the conclusion of the course (location 298). Once the course is complete, a record of such is provided to the resource index database.

As indicated the professional distance education system could also be employed in the manner similar to the course module for the purposes of certifying a student for a particular task (locations 302, 304 and 306). As indicated the course module may conclude with a final exam. This exam may take place on a particular test date during which the user would log on to the system by presenting their user name and password (location 308). The test could consist of both multiple choice and essay portions (locations 310 and 312). The exam would be scored and graded and again with reference to the resource index database (locations 314 and 316). This course would then be reported to the student and stored in the database and a certificate of completion could be sent to the student (locations 318 and 320).

### Best Practices Database

In yet another aspect of the present invention, a best practices database is provided as an educational tool for EDP. Again, this feature would be carried out over the Internet with a database and server being remotely accessed via one or more webpages. This feature of the invention is prompted by the fact that the economic development industry has no dynamic database for the capture, cataloging and dissemination of case studies related to best practice models. These case studies would be authored by subject matter experts, consultants, and economic development practitioners. Thus, this best practices database would be built by others in a real time scenario and indexed by topical subject and placed in chronological order. This database would allow not only experts to post their real world experiences for other to review, but would also allow others to do best practice reviews through on-line information searches using a server based search tool to find the most relevant best practice examples related to their desired topic.

The database would allow industry professionals to build a distinct information file regarding projects they have been involved with developing. It would use specific templates for creating specialized topic area descriptions of the project via pre-determined defined topics and required information fields. This template would allow the information provider to submit their information along with files and hyper-links to a relevant specialized topic area description to thereby create a project overview file along with all relevant information included by the industry professional. Once the file is created the user would be notified if any fields are incomplete and/or missing critical information prior to posting the new project to the database for inclusion in future inquiry information searches. Information seekers will create a subject matter driven search by filling out a template to search the database for relevant examples.

More specifically, industry professionals posing best practice examples would be prompted for the following information:
Project Type—Industrial, Commercial, Retail, Entertainment/Tourism, Research & Development, Infrastructure Improvements, etc.;
Abstract Description—short paragraph describing the project purpose, outcome expectations, and economic impact achieved;
Sub-Levels—(specialized topic areas) example waterfront, business park, redevelopment, new development, brownfield reuse, base closure mitigation, airparks, downtown development, historic renovation & redevelopment, etc.;
Impacted Priorities—Job creation, Economic Diversification, Increased Tax Base, Environmental mitigation, new business industry cluster attraction, catalyst project leverage, ancillary spin-off project development, etc.;
Outcome Measurements—practical examples of benchmarking, goals & expectations, outcome return on investment (ROI) models;
Project Primary Published Reports—information provided pre and post project to the elected and appointed officials, media and information materials along with specialized reports prepared by expert consults. This will have fields for type of media (staff report, press release, consultant report) and hyper-links to relevant websites for examples and references.
Desirability/Outcome Rating—a sliding scale of achievement rating of this project from the participants stand-point and/or client: 1=failed to achieve desired outcome 2=poor results due to unanticipated obstacles 3=some positive benefits (outcomes not fully realized) 4=positive outcome and outcomes attained 5=Exceptional outcome and outcomes greater than expected;
Lessons Learned—
   Positive outcomes and what caused them to work properly (list info)
   Negative outcomes, why they failed, mitigate techniques in the future (list info)
   Barriers to consider pre-project (list info)
   Unforeseen obstacles (list info)
   Major accomplishments related to the project (list info);
Project URL—This will allow the posing participant to create a hyper-link to the project if one exists for ease of access for references;

After the information is posted to the database, individuals seeking information on best practices can search via a subject matter drop down menu and key word driven search tool. This will post the best results in a hierarchal order such as most recent, most appropriate key word inclusion by percentage of word match. The information seeker may then click on the abstract to review the project file prior to deciding whether to purchase a larger, more detailed report. Economic developers will use this system to find real life information about projects that might assist them in better understanding how to approach their own projects prior to commencement. Subject matter experts/consultants can display their work with their biographical information for consideration by clients when seeking expert advice on such topics. Economic Developers will pay for the search on a fee based scale either one time and/or by annual contract. Consultants will pay to post their biographies and business information for consideration by clients on a fee based annual contract basis.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

1. A method of employing a computer network in disseminating information to economic development practitioners (EDPs), the method comprising the following steps:
assigning a user name and password to an individual EDP utilizing the network and enabling the EDP to access a database containing a listing of various economic development courses and descriptions of the economic development courses, allowing an individual EDP to select a desired course, storing in a database the user name and selected course;
storing economic development articles and summaries of economic development websites in a resource index database and permitting individual EDPs to access and search the database for information relevant to their selected economic development course;
indexing the stored economic development articles into the following categories: waterfront, business part, redevelopment, new development, brownfield reuse, base closure mitigation, airports, downtown development, historic renovation and redevelopment;
updating the resource index database with relevant websites by permitting EDPs to submit URLs for inclusion in the resource index database;
automatically categorizing the URLs submitted by EDPs, on the basis of search phrases found on web pages associated with the URLs, automatically summarizing the web pages associated with the URLs by way of a document summary engine, providing the categorized URLs and web page summaries to the resource index database, such that the web pages can be accessed by EDPs;
providing EDPs with reading assignments selected from the economic development articles and summaries of economic development websites stored in the resource index database, the reading assignments being assigned on the basis of a desired course selected by an EDP;
storing test questions and answers in the resource index database, the test questions being classified on the basis of the economic development courses, permitting individual EDPs to access the test questions but not the test answers, such that the EDPs may provide answers;
grading the answers to the test questions by comparing the answers provided by the EDPs to the answers stored in the resource index database, assigning a course grade to the EDP on the basis of the grading;
assigning a chat room session code on the basis of the assigned course grade, the session code enabling the EDP to access an on-line chat session at a designated date and time, reminding the EDP of the designated date and time via e-mail, the chat room session being conducted with a relevant subject matter expert with expertise in a specific field of economic development such that the subject matter expert can answer any questions posed by the EDP relevant to the selected economic development course in an on-line format;
compiling a record of courses taken by an individual EDP and storing such record in the resource index database;
sending an on-line newsletter to EDPs over the network, the newsletter concerning economic development issues, storing the on-line newsletter in the database for future reference by EDPs.

2. A method of employing a computer network in disseminating information to economic development practitioners (EDPs), the method comprising the following steps:
enabling the EDPs to access a database containing a listing of various economic development courses and allowing an individual EDP to select a desired course;
storing economic development information in a resource index database and permitting individual EDPs to access and search the database for information relevant to their selected economic development course;
storing test questions and answers in the resource index database, the test questions being classified on the basis of the economic development courses, permitting individual EDPs to access the test questions but not the test answers, such that the EDPs may provide answers;
grading the answers to the test questions by comparing the answers provided by the EDPs to the answers stored in the resource index database, assigning a course grade to the EDP on the basis of the grading;
periodically updating the resource index database with web pages submitted by EDPs, automatically indexing and summarizing the web pages for reference by other EDPs;
providing EDPs with reading assignments from the economic development information stored in the database, the reading assignments being assigned on the basis of a desired course selected by an EDP;
enabling the EDP to access an assigned on-line chat session at a specified date and time with a relevant subject matter expert with expertise in a specific field of economic development such that the subject matter expert can answer any questions relevant to the selected economic development course, the EDP being reminded of the specified date and time via e-mail, the on-line chat session being assigned on the basis of the assigned course grade.

3. The method as described in claim 2 wherein user names and passwords are assigned to individual EDPs prior to utilizing the network.

4. The method as described in claim 2 wherein the economic development information includes economic development articles and summaries of economic development websites.

5. The method as described in claim 2 wherein test questions and answers are stored in the resource index database, the test questions being classified on the basis of the economic development courses, and wherein individual EDPs are given access the test questions and wherein the EDPs provide answers to the test questions.

6. The method as described in claim 5 wherein the answers to the test questions are graded by comparing the answers provided by the EDPs relative to the answers stored in the resource index database, assigning a course grade to the EDP on the basis of the grading.

7. The method as described in claim 6 wherein a chat room session code is assigned to the EDP on the basis of the assigned course grade, the session code giving the EDP access to a relevant on-line chat session.

8. The method as described in claim 2 wherein a record is complied of courses taken by an individual EDP and wherein such compiled information is stored in the resource index database.

9. A method of employing a computer network in disseminating information to economic development practitioners (EDPs), the method comprising the following steps:
assigning a user name and password to an individual EDP utilizing the network;
enabling the EDPs to access a database containing a listing of various economic development courses and allowing an individual EDP to select a desired course;
storing economic development information in a resource index database and permitting individual EDPs to access and search the database for information relevant to their selected economic development course;
sending an on-line newsletter to EDPs over the network, the newsletter concerning economic development issues, storing the on-line newsletter in the database for future reference by EDPs.
